(19) United States
(12) Patent Application Publication
(10) Pub. No.: US 2024/0052512 A1
(43) Pub. Date: Feb. 15, 2024

(54) 3D PRINTING DEVICE USING SELECTIVE ELECTROCHEMICAL DEPOSITION, AND CONTROL METHOD THEREFOR

(71) Applicant: ANYCASTING CO., LTD., Seoul (KR)

(72) Inventors: Sungbin KIM, Seoul (KR); Kunwoong KO, Seoul (KR); Donghyeon LEE, Incheon (KR)

(73) Assignee: ANYCASTING CO., LTD., Seoul (KR)

(21) Appl. No.: 18/266,800

(22) PCT Filed: Dec. 21, 2020
(86) PCT No.: PCT/KR2020/018838

§ 371 Date: Jun. 12, 2023

(51) Int. Cl. C25D 1/00; B33Y 10/00; B33Y 30/00

(52) U.S. Cl. CPC C25D 1/003; B33Y 10/00; B33Y 30/00

(57) ABSTRACT

The present invention relates to a 3D printing device using selective electrochemical deposition and particularly to a 3D printing device capable of selectively depositing metal materials onto a substrate by using additive manufacturing by electrochemical deposition (electrochemical additive manufacturing, ECAM).

### TECHNICAL FIELD

The present disclosure relates to a three-dimensional (3D) printing device using selective electrochemical deposition, and more particularly to a 3D printing device for selectively stacking a metal raw material on a substrate using electrochemical additive manufacturing (ECAM) using electrochemical deposition.

### BACKGROUND ART

Three-dimensional (3D) printing technology uses additive manufacturing, which stacks materials such as polymeric materials, plastics, or metal powder, based on three-dimensional design data, to shape physical models, prototypes, tools, and parts.

As a 3D printing method, liquid-based and powder-based methods are mainly used depending on the characteristics of a raw material used. In the liquid-based method, layers are stacked one by one according to a shape of an object using polymer synthetic resin in a liquid state and then the stacked structure is photocured. In the powder-based method, a metal raw metal made in the form of powder is melted or sintered.

A 3D printer using polymers or plastics as a raw material is implemented in a liquid-based method and is widely used, but a 3D printer using a metal raw material is difficult to implement in a liquid-based method and is implemented only in a powder-based method. Therefore, the 3D printer using a metal raw material is not widely used unlike the 3D printer using a plastic raw material for reasons such as high material prices, complicated processing methods, high sintering temperatures, and explosion hazards.

As the cited references to resolve this problem, Korean Patent No. 10-1774383 (registration publication date: Aug. 29, 2017) and Korean Patent No. 10-1774387 (registration publication date: Aug. 29, 2017) and Korean Patent No. 10-1913171 (registration publication date: Oct. 24, 2018) disclose a “3D printing device using selective electrochemical deposition”.

However, since the 3D printing device according to the cited references basically use an electrochemical method, there is a problem in that a stacking speed is slow. In addition, the cited references disclose features for controlling a stacking height, but do not disclose specific control features. Also, specific features of motion control of an electrode module for 3D printing are not disclosed.

In the case of general 3D printing, motion control of a printer filament is performed using a G code processed by slicing software. However, in the case of an additive 3D printer using electrochemical deposition as in the cited references, the additive mechanism is different from that of general 3D printing. This is because the former performs printing by controlling a heater and a fan and controlling an extrusion amount of the filament, while the latter performs 3D printing by controlling the current of an electrode module.

Therefore, a control method and algorithm applicable to electrochemical additive manufacturing (ECAM) 3D printers are required. Needless to say, the cited references do not specifically disclose such a control method.

In the case of an ECAM 3D printer, it is very necessary to ensure a uniform stacking thickness and increase a stacking speed. In addition, since the ECAM 3D printer is a 3D printer, it is very important to ensure printing performance during horizontal movement as well as vertical movement of an electrode module. Therefore, a method for satisfying these needs is very necessary.

### DISCLOSURE

### Technical Problem

The present disclosure may provide a three-dimensional (3D) printing device using a new type of electrochemical additive manufacturing (ECAM).

An embodiment of the present disclosure may provide a 3D printing device using ECAM in which gap control is effectively performed and a control method thereof.

An embodiment of the present disclosure may provide a 3D printing device using ECAM that satisfies stacking speed and stacking uniformity and a control method thereof.

An embodiment of the present disclosure may provide a 3D printing device using ECAM for a single brush when it is not possible to draw a layer with a complex 3D shape via the single brush and a control method thereof.

An embodiment of the present disclosure may provide a 3D printing device using ECAM that diversifies a power supply method and performs optimal 3D printing according to a 3D shape to be printed flexibly by diversifying the Z-axis control logic in each power supply method, and a control method thereof.

### Technical Solution

To achieve the above purposes, according to an embodiment of the present disclosure, a three-dimensional (3D) printing device includes a tub accommodating an electrolyte, a substrate placed in the tub, an electrode module, a module driver configured to drive the electrode module and adjust 3D movement including movement in a direction toward a gap between the electrode and the substrate, an AD converter configured to connect the electrode module and the substrate to different polarities and including a switching part, a first power supply selectively connected to the AD converter through the switching part, a second power supply selectively connected to the AD converter through the switching part and having a different power supply method from the first power supply, and a main controller configured to control the module driver and the switching part, wherein the main controller controls the gap by changing a method of supplying power to the AD converter.

The main controller may change the method of supplying power to the AD converter as a stacking height per cycle varies according to a stacked layer of the metal raw material.

The main controller may change the method of supplying power to the AD converter as a stacking shape per cycle varies according to a stacked layer of the metal raw material.

The main controller may change the method of supplying power to the AD converter as a stacked layer of a metal raw material varies.

When one layer is 3D printed, a plurality of cycles may be performed. In the case of 3D printing of one layer, one cycle may be performed. Here, one cycle means that power is applied and printing is continuously performed. In other words, a period from start of drawing with a single brush through the electrode to the end may be one cycle.

The main controller may change a method of supplying power to the AD converter after stacking is performed up to a preset height.

The first power supply may be a power supply that supplies a pulse, and the second power supply may be a power supply that supplies constant current or constant voltage.

The switching part may be driven to be selectively connected to any one of the first power supply and the second power supply for 3D printing.

The switching part may include a connection on/off switch of the first power supply and a connection on/off switch of the second power supply.

Rise control of the electrode for the gap control may include at least one of post-gap control performed after 1-cycle shift stacking or intermediate gap control performed during 1-cycle shift stacking.

Here, one layer may be formed through a plurality of cycles, and one layer may be formed through one cycle. Thus, post-gap control may be performed after one layer is stacked, and intermediate gap control may be performed during stacking of one layer.

The post-gap control may be performed in a next cycle (or next layer) based on a rise amount calculated after the 1-cycle shift stacking is completed (or after completion of stacking one layer). This may be called a calculation rise method or calculation rise logic.

The post-gap control may be performed in a next cycle (or next layer) based on a preset rise amount after the 1-cycle shift stacking is completed (or completion of stacking one layer). This may be called a fixed rise method or a fixed rise logic.

The intermediate gap control may be performed during 1-cycle shift stacking (or during stacking of one layer) based on an increase amount determined through feedback during 1-cycle shift stacking (or during stacking of one layer). The intermediate gap control may be performed during the 1-cycle shift stacking (or during stacking of one layer) based on a rise amount determined through feedback during the 1-cycle shift stacking (or during stacking of one layer). This may be called an instantaneous rise method or instantaneous rise logic.

The main controller may control power to be supplied through the first power supply at beginning of stacking, and then control power to be supplied through the second power supply. That is, the first power supply may be used from the bottom to a predetermined floor, and the second power supply may be used from a next floor.

The main controller may control power to be supplied to a preset stacking height through the first power supply and then control power to be supplied until end of stacking through the second power supply.

Here, the main controller may be configured to control on/off of the first power supply and the second power supply. The main controller may be selectively connected to the first power supply and the second power supply. That is, the main controller may be provided to control on/off of each power supply and control on/off of both connections.

When the first power supply is a function generator, the supplied current or voltage may be small. Therefore, in this case, the current or voltage may be supplied to the AD converter after being amplified. Needless to say, power input from the AD converter may be supplied to a load.

In this case, power channel 1 may be turned off and power channel 2 may be turned on. The first power supply and the second power supply may be connected to each other. Therefore, pulse input generated and input from the first power supply may be amplified by the second power supply and then supplied to the AD converter through power channel 2.

Therefore, in the present embodiment, there may be a form in which power is applied to the AD converter through only each power supply, and there may also be a form in which power is applied to the AD converter through power supplies connected to each other. In the end, three different power sources may be supplied through two power supplies.

The AD converter may include a channel connector to which the first power supply and the second power supply are each connected, a control module including the switching part and configured to control a connection channel and output, and a communication module configured to communicate with the main controller.

The control module may control an operation of the AD converter autonomously.

The AD converter may include an output on/off switch. That is, even if power is applied through the power supply to the current AD converter, output may be turned on/off instantaneously.

The switching part may include a switch configured to turn on/off each of a channel connected to the first power supply and a channel connected to the second power supply.

The AD converter may include a peak detector configured to detect a peak of output, and the control module may be configured to measure an input voltage and measure current through the peak of the output detected by the peak detector

The AD converter may include a display configured to display a currently connected power input channel and the measured voltage and current.

The main controller may transfer information on a power input channel selected by the control module and output on/off information to the AD converter through the communication module, and the AD converter may transfer the measured input voltage and current to the main controller through the communication module

To achieve the above purposes, according to an embodiment of the present disclosure, a method of controlling a 3D printing device includes supplying current between an electrode module and a substrate through an AD converter from a first power supply connected to a first channel of the AD converter, performing first printing in which power is supplied through the first power supply and then gap rise control of the electrode module is performed, supplying current between the electrode module and the substrate through the AD converter from a second power supply connected to a second channel of the AD converter, and performing second printing in which power is supplied through the second power supply and then the gap rise control of the electrode module is performed, wherein the second power supply has a different power supply method from the first power supply.

Conditions for distinguishing first printing from second printing may be provided, and when these conditions are satisfied, conversion from first printing to second printing may be performed.

The distinguishing condition may correspond to a stacking height. That is, the first printing may be performed up to a set stacking height after printing starts, and then the second printing may be performed. Accordingly, whether the division condition is satisfied may be determined.

The first power supply may be a power supply supplying a pulse, and the second power supply may be a power supply supplying a constant current or constant voltage. Therefore, a uniform stacking width may be ensured using pulse power in an initial stage of stacking, and a stacking speed may be accelerated using a constant current or constant voltage power supply thereafter.

The power supply method may be easily changed through the AD converter, and cycle average current may be easily obtained by sampling a pulse current peak value very quickly through the AD converter. Smooth gap control may be performed even when pulse power is supplied using the cycle average current.

The method of supplying power to the AD converter may be changed as a stacking height per cycle varies according to a stacked layer of the metal raw material

The method of supplying power to the AD converter may be changed as a stacking shape per cycle varies according to a stacked layer of the metal raw material.

The method of supplying power to the AD converter may be changed as a stacked layer of a metal raw material varies.

In the control method according to the present embodiment, the first power supply may be a power supply that supplies a pulse, and the second power supply may be a power supply that supplies constant current or constant voltage.

Rise control of the electrode for the gap control may include at least one of post-gap control performed after 1-cycle shift stacking or intermediate gap control performed during 1-cycle shift stacking.

In the AD converter, the control method may include measuring input voltage for the gap control and measuring current through the peak of the output detected by the peak detector.

The post-gap control may be performed in a next cycle based on a rise amount calculated after the 1-cycle shift stacking is completed.

The post-gap control may be performed in a next cycle based on a preset rise amount after the 1-cycle shift stacking is completed.

The intermediate gap control may be performed during the 1-cycle shift stacking based on a rise amount determined through feedback during the 1-cycle shift stacking.

The control method of the 3D printing device includes driving a leveling device to adjust a level of the substrate.

The control method according to the present embodiment may include adjusting the temperature of the electrolyte by driving a thermostat.

The control method according to the present embodiment may include adjusting a concentration of the electrolyte by driving a concentration control device.

In the control method according to the present embodiment, the first printing may be performed at beginning of stacking, and then the second printing may be performed.

In the control method according to the present embodiment, the first printing may be performed up to a preset stacking height, and then the second printing may be performed.

### Advantageous Effects

An embodiment of the present disclosure may provide a three-dimensional (3D) printing device using a new type of electrochemical additive manufacturing (ECAM).

An embodiment of the present disclosure may provide a 3D printing device using ECAM in which gap control is effectively performed and a control method thereof.

An embodiment of the present disclosure may provide a 3D printing device using ECAM that satisfies stacking speed and stacking uniformity and a control method thereof.

An embodiment of the present disclosure may provide a 3D printing device using ECAM for a single brush when it is not possible to draw a layer with a complex 3D shape via the single brush and a control method thereof.

An embodiment of the present disclosure may provide a 3D printing device using ECAM that diversifies a power supply method and performs optimal 3D printing according to a 3D shape to be printed flexibly by diversifying the Z-axis control logic in each power supply method, and a control method thereof.

### DESCRIPTION OF DRAWINGS

FIG. 1 is a diagram schematically showing a three-dimensional (3D) printing device according to an embodiment of the present disclosure.

FIG. 2 is an enlarged schematic diagram of a power supply shown in FIG. 1.

FIG. 3 shows a basic flowchart of 3D printing according to an embodiment of the present disclosure.

FIG. 4 shows a printing flow using a 3D printing device according to an embodiment of the present disclosure.

FIG. 5 shows a control configuration of a 3D printing device according to an embodiment of the present disclosure.

FIG. 6 shows a control configuration of a 3D printing device in terms of an AD converter according to an embodiment of the present disclosure.

### BEST MODE

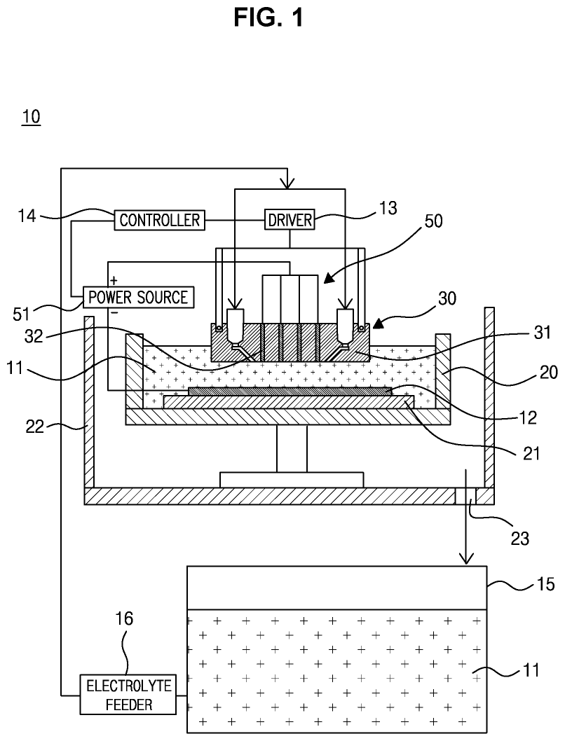

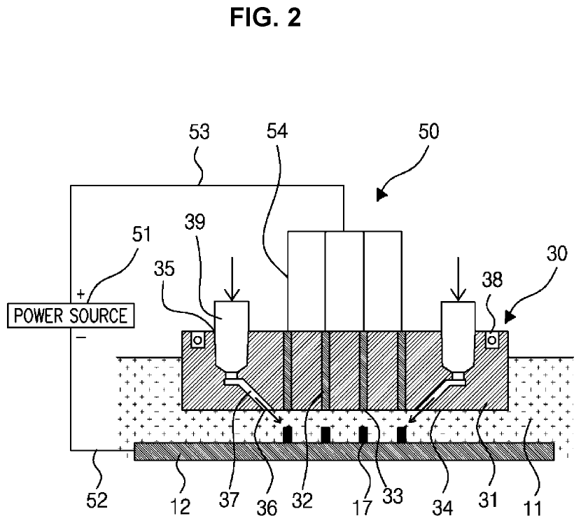

FIG. 1 is a diagram schematically showing a three-dimensional (3D) printing device according to an embodiment of the present disclosure, and FIG. 2 is a diagram schematically showing a state in which power is applied to a substrate and an electrode.

Referring to FIGS. 1 and 2, a 3D printing device 10 according to an embodiment of the present disclosure may include a tub 20 accommodating an electrolyte 11, a substrate 12 placed in an immersed state in the electrolyte 11 accommodated in the tub 20, a multi-electrode module 30 including an electrode holder 31 and a plurality of electrodes 32 arranged and fixed at predetermined intervals to the electrode holder 31, a driver 13 controlling movement of the multi-electrode module 30, a power supply 50 supplying power to the substrate 12 and the plurality of electrodes 32, and a controller 14 controlling the driver 13 and the power supply 50 and selectively electrodepositing and stacking metal icons included on the electrolyte 11 on the substrate 12.

The substrate 12 and the bottom surfaces 33 of the plurality of electrodes 32 may face each other, may be spaced apart from each other by a predetermined distance, and may be immersed in the electrolyte 11 accommodated in the tub 20.

For example, the substrate 12 may be immersed in the electrolyte 11 accommodated in the tub 20 while being placed on the support 21 provided in the tub 20, and the bottom surfaces 33 of the plurality of electrodes 32 may be immersed in the electrolyte 11 accommodated in the tub 20 according to movement of the multi-electrode module 30 by an operation of the driver 13 and may be spaced apart from the substrate 12 by a predetermined distance.

In the state in which the substrate 12 and the bottom surfaces 33 of the plurality of electrodes 32 face each other at a predetermined interval and are immersed in the electrolyte 11 accommodated in the tub 20, when the controller 14 may control the power supply 50 to control the plurality of electrodes 32 to (+) and the substrate 12 to (−) to apply power to the substrate 12 and the plurality of electrodes 32, metal icons included in the electrolyte 11 may be stacked on the substrate 12 while being electrochemically deposited on a region 17 of the substrate 12, which faces the bottom surfaces 33 of the electrodes 32.

Accordingly, the controller 14 may control the driver 13 and the power supply 50 to selectively electrodeposit and stack metal ions included in the electrolyte 11 on the substrate 12. That is, the metal ions in the electrolyte may be solidified, electrodeposited, and deposited on the substrate 12. In other words, a metal raw material may have a 3D shape and be formed on a substrate.

The driver 13 is a component for controlling movement of the multi-electrode module 30, and may drive the multi-electrode module 30 in horizontal and vertical directions.

For example, the driver 13 moves the multi-electrode module 30 horizontally to select a stacking position of the substrate 12. After stacking is performed at a predetermined height, for example, after one predetermined layer is completely stacked, a distance between the substrate 12 and the bottom surfaces 33 of the plurality of electrodes 32 may be adjusted by moving the multi-electrode module 30 in a vertical direction by approximately a height at which the one layer is stacked.

That is, the driver 13 may drive the multi-electrode module 30 to adjust a 3D displacement including a gap between the substrate 12 and the bottom surfaces 33 of the plurality of electrodes 32.

The power supply 50 may be provided to simultaneously apply power to the plurality of electrodes 32.

In detail, the power supply 50 may include a power source 51, a substrate connector 52 connecting the power source 51 to the substrate 12, a main connector 53 connecting the power source 51 to the plurality of electrodes 53, and a sub connector 54 connecting the main connector 53 and each of the plurality of electrodes.

Here, the sub connector 54 may be provided to arrange the plurality of electrodes in parallel.

Accordingly, when power is applied by the power supply 50, power may be applied to the plurality of electrodes 32 at the same time. Then, as shown in FIG. 2, each of the plurality of electrodes 32 is simultaneously multi-layered, thereby increasing the overall printing speed.

The multi-electrode module 30 is a component for fixing the plurality of electrodes 32 and may include the electrode holder 31 in which the plurality of electrodes 32 are arranged and fixed at predetermined intervals.

In addition, the plurality of electrodes 32 may be fixed in a state of penetrating the electrode holder 31, and in this case, the bottom surfaces 33 of the plurality of penetrating electrodes 32 may be placed horizontally with respect to a bottom surface 34 of the electrode holder 31.

When electrochemical deposition occurs if power is applied to the substrate 12 and the plurality of electrodes 32, air bubbles are generated. Since these air bubbles interfere with stable electrochemical deposition and degrade stacking quality, it is necessary to smoothly remove the generated air bubbles in order to improve the stacking quality.

However, when the bottom surfaces 33 of the plurality of penetrating electrodes 32 are placed inward from the bottom surface 34 of the electrode holder 31 to form a predetermined space or protrude beyond the bottom surface 34 of the electrode holder 31, the generated air bubbles may not be smoothly removed while staying in the space or sticking to a portion of the protruding electrode 32.

Therefore, in order to improve the stacking quality, the bottom surfaces 33 of the plurality of electrodes 32 may be level with the bottom surface 34 of the electrode holder 31.

The electrode holder 31 may be made of a plastic material, and the multi-electrode module 30 may be manufactured by immerging the electrode holder 31 made of plastic in water at a temperature higher than room temperature to ensure ductility, and then press-inserting the plurality of electrodes 32 into the electrode holder 31 having the ensured ductility at predetermined intervals.

In this case, the bottom surfaces 33 of the plurality of electrodes 32 and the bottom surface 34 of the electrode holder 31 may be leveled by polishing the entire bottom surface 34 of the electrode holder 31.

The inlet 35 may be formed in a top surface of the electrode holder 31, the inlet 35 may be coupled with nozzles 39 that eject the electrolyte supplied from the electrolyte feeder 16 at a predetermined pressure, and a coupler 38 for fixing to the driver 13 may be formed on the top surface of the electrode holder 31.

The 3D printing device 10 according to an embodiment of the present disclosure may be configured to smoothly remove the generated bubbles.

To this end, the 3D printing device 10 may include a storage 15 storing the electrolyte 11 therein, and an electrolyte feeder 16 for feeding the electrolyte 11 stored in the storage 15 to the tub 20.

The electrolyte feeder 16 may be used with any pump. However, the present disclosure is not limited thereto, and the electrolyte 11 stored in the storage 15 may be fed to the tub 20 using a height difference.

The electrode holder 31 may include an inlet 35 into which the electrolyte supplied from the electrolyte feeder 16 flows, an outlet 36 through which the electrolyte introduced through the inlet 35 is ejected into the substrate 12, and an ejection flow path 37 connecting the inlet 35 and the outlet 36.

As shown in FIG. 2, the ejection flow path 37 may be inclined such that when the electrolyte introduced through the inlet 35 is ejected through the outlet 36, the electrolyte is ejected toward a region in which the plurality of electrodes is provided.

Then, when power is applied to the substrate 12 and the plurality of electrodes 32 and electrochemical deposition occurs, air bubbles generated may be smoothly removed.

The outlet 36 may be formed on the bottom surface 34 of the electrode holder 31 and may be formed long at one side of an edge of a region in which the plurality of electrodes 32 are provided. Then, the generated air bubbles may be removed more smoothly.

The 3D printing device 10 according to an embodiment of the present disclosure may include an auxiliary tub 22 accommodating the tub 20.

The auxiliary tub 22 may be provided with a discharge 23 for discharging electrolyte overflowing from the tub 22 to the storage 15.

Therefore, when the electrolyte feeder 16 is used as a predetermined pump, the electrolyte 11 may circulate through the tub 20 and the storage 15 by the electrolyte feeder 16 and the discharge 23.

In the above, with reference to FIGS. 1 and 2, the overall configuration of the 3D printing device according to an embodiment of the present disclosure has been briefly described. In the described example, the electrode module includes multiple electrodes, but may be provided with one electrode instead of multiple electrodes.

When performing 3D printing using one electrode or 3D printing using multiple electrodes, it is very important to effectively and accurately control a vertical distance between the electrode and the substrate, that is, a gap. This may be very different from general 3D printing. This is because the printing device according to the present embodiment performs 3D printing through electrodeposition and stacking of a metal raw material in an ionic state rather than a powder or liquid state.

Hereinafter, a control method and control configuration of a 3D printing device according to an embodiment of the present disclosure will be described in more detail.

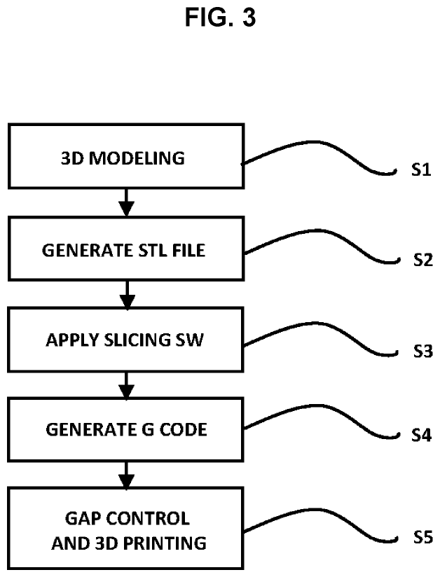

FIG. 3 illustrates an operation or control flow of a printing device according to an embodiment of the present disclosure.

In order to print a 3D shape, 3D modeling is first performed (S1). That is, a 3D shape to be printed is modeled by CAD. Then, a modeling file is converted into an STL file. That is, the STL file is created (S2).

Stereo lithography (STL) may be a file format provided to save 3D modeled data as a standard file.

Each 3D graphics software has a different format for saving files, but most of the files may be compatible with STL files. The STL files are arguably the most widely used files in the 3D industry. According to the STL, a three-dimensional model is configured with triangular surfaces, and has an advantage of designing a model close to a circular shape by finely adjusting the model. Needless to say, the 3D modeling data may be used without being converted into an STL file, or converted into other types of files for use. Then, after the STL file is input by applying slicing software (S/W) or a program STL file is input (S3), a G-Code is generated through a scale, a stacking condition, and environment settings (S4).

Steps S1 to S4 may be steps commonly used in most 3D printing devices.

A slicing program is a program that automatically builds up one level at a time to make a path for a 3D printer to create a shape when a user inputs a 3D model and printer settings during use of the 3D printer. There are several types of slicing programs.

Most 3D printers may have dedicated slicing programs, and commercial slicing programs are also available.

A G code file generated by a commercial slicing program may not be used as it is in the 3D printing device according to the present embodiment. This is because the G code generated by the commercial slicing program is suitable for stacking mechanisms such as compression. That is, the G code is not suitable for a mechanism for stacking using electrochemical deposition as in the present embodiment.

Therefore, the G code needs to be reinterpreted according to the present embodiment, and in the present embodiment, 3D printing is performed (S5) by applying a gap control logic.

Step S5 includes programmatically reinterpreting the G code to be applied to one embodiment of the present disclosure, and performing 3D printing by applying the gap control logic after the reinterpretation. Needless to say, input and interpretation of the G code, gap control, and 3D printing may be performed in real time without distinction.

Here, depending on a slicing program, G-CODE is used as a name such as tool path or tool path, and all of them may be the same.

In the present embodiment, 3D printing may be performed by receiving the generated G code, reinterpreting the G code, and applying the gap control logic.

Gap control will be described in more detail.

The 3D printing device according to the present embodiment uses electrochemical additive manufacturing (ECAM) as described above. For example, copper may be layered by connecting power to an electrode made of platinum and connecting power to a substrate immersed in electrolyte. In this case, when a distance between an anode and a cathode changes, an applied voltage and a current diffusion area change, and thus a Z-axis control technique for maintaining an optimal gap between an electrode and a stack is required. That is, the gap control technique or logic may be required.

A layer height value is also set in the G code. That is, after forming each layer, a value at which a filament moves vertically is set to form a next layer. 3D printing may be performed through these setting values.

However, it is not easy to actually apply the layer height value set in the G code in the present embodiment. This is because, in the ECAM-applied 3D printing device, a 1-cycle stacking height is different from the layer height value in the G code. More specifically, the 1-cycle stacking height varies depending on a size of the electrode and a gap between the substrate and the electrode. In particular, the 1-cycle stacking height may vary according to the current or voltage setting, and the 1-cycle stacking height may also vary according to a required stacking shape.

In the 3D printing device to which the ECAM according to the present embodiment is applied, power supply specifications and Z-axis rising algorithms suitable for the stack height or stack shape may be differently applied. That is, different types of power may be supplied during a 3D printing process, and different gap control methods may be applied.

The present inventor tries a constant voltage or constant current method as a power supply method in a 3D printing device to which ECAM is applied. In this case, it is seen that a shape of a stacked structure is grown in the form of Gaosian due to current diffusion. That is, it is seen that the stacked structure is formed in a form in which a width is relatively large in initial stacking (later) and becomes relatively small as stacking proceeds. For example, it is seen that a width of 100 micrometers is formed in an initial layer and then the width increases to about 50 micrometers upwards. Such a shape is referred to as an elephant foot shape.

On the other hand, when a pulse on/off power supply method id applied, there is a problem in that a stacking time increases even though growth of the Gaussian shape is prevented. That is, it is possible to achieve an increase with a relatively small change toward a top layer from a bottom layer, but there is a problem in that a stacking time is increased.

Therefore, in the present embodiment, the advantages and disadvantages of different power supply methods are complemented to reduce the uniform growth and stacking time.

The power supply method in the present embodiment may include at least one of a constant current supply method, a constant voltage supply method, and a pulse supply method. In particular, a pulse supply method and a different type of supply method may be interchangeably used.

In addition, in the present embodiment, a Z-axis rising logic (gap control logic) may be provided for each power supply method.

First, the gap control logic in a constant current supply method will be described.

A calculation rise logic, a fixed rise logic, and an instantaneous rise logic may be provided in the constant current supply method. Any one method may be applied, and these methods may be used in combination.

The calculation rise logic may be a method of obtaining an average value of voltages measured during one cycle after 1-cycleshift stacking, and giving a gap rise amount using the average value.

Specifically, a difference between the average voltage obtained at the end of one cycle and a set voltage may be obtained, and the difference may be multiplied by a set height. Here, the set height may be a height set in the G code. Therefore, the gap rise is performed by driving the electrode module in the driver by applying the set height calculated at the end of one cycle.

Here, the set voltage may be set to a voltage measured in a gap between the initial electrode and the substrate, the set height may be set in units of micrometers per voltage (V) to calculate a desired Z-axis rise amount, and an average voltage of one cycle may be calculated automatically by a program.

For example, when the set voltage is 5 V and the average voltage of one cycle is 0 V, and the set height is 2 μm/V., the Z-axis rise amount (gap rise amount) becomes 10 μm. In addition, when the set voltage is smaller than the average voltage of one cycle, the gap may not rise.

The fixed rise logic is a logic that gives an increase by a set value after stacking is completed for each cycle, That is, the set height may be preset in micrometers per cycle.

The instantaneous rise logic is a logic that gives an increase or decrease after comparing a current voltage value and a set voltage value for each set time (for example, 0.05 seconds) during stacking movement. That is, instantaneous rise may be referred to as immediate gap control.

In the present embodiment, it is possible to interchangeably use three gap control methods.

For example, when all three gap control methods are used, the Z-axis rises or falls due to an instantaneous rise during one cycle, and after one cycle is completed, Z-axis rise may be achieved by the sum of the calculated rise amount and the fixed rise amount.

Next, gap control logic in a pulse supply method will be described.

The calculation rise logic is to measure and use a peak value of an on-time current within each pulse width during 1-cycle shift stacking. A difference between a cycle average current and a set current obtained for each on-time period of one cycle is multiplied by the set height. The rise or maintenance may be repeated by the Z-axis rise obtained in this way.

Here, it may be seen that when a period (on/off time) value is not input in pulser setting, a constant voltage supply method may be used. Therefore, it may be seen that the calculation rise logic is used even in the constant voltage supply method.

The set current is a current measured in a gap between the initial electrode and the substrate and may be set in units of mA. The set height may be set in height per current (μm/mA) to calculate the desired Z-axis rise. The cycle average current may be automatically calculated in the program.

When a value calculated in the calculation rise logic is negative (when the set voltage is lower than the obtained average voltage), the gap may be maintained. This is opposite to the constant current method because the constant voltage is 0 V and the constant current has the maximum output during electrical connection.

The fixed rise logic is the same as in the constant current method.

The instantaneous rise logic may be a method of rising or falling after comparing the current peak value measured during stacking movement with the set current value for every set time (for example, 0.05 seconds).

As in the constant current method, it is possible to interchangeably use the three Z-axis control logics in the same way as in the constant voltage method or the pulse method.

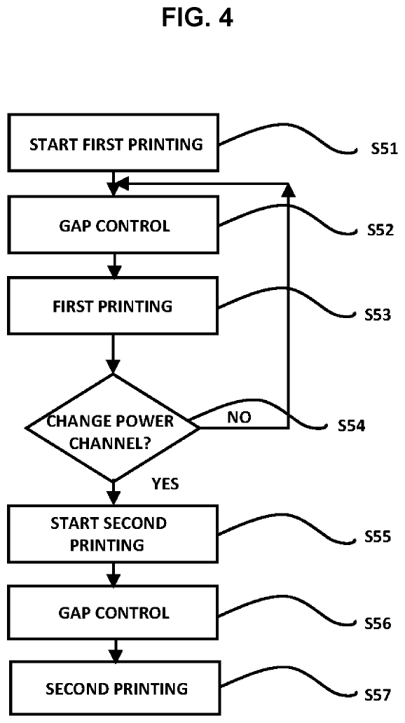

As described above, according to the present embodiment, the gap control logic is applied in 3D printing by stacking (S5). This will be described in more detail with reference to FIG. 4.

In the present embodiment, a step of performing 3D printing using different power schemes may be included.

First, when first printing starts (S10), the first printing (S12) is performed through power supplied from a first power supply device, and at this time, gap control (S11) may be performed. Here, the first power supply device may be a pulse supply type power supply device as will be described later. At this time, the gap control may apply all of the three logics described above.

While the first printing is performed, whether or not a power channel change condition is satisfied may be determined (S13). This may correspond to a stack height or a stack time. A stacking condition may be variously set. For example, the stacking condition may be referred to as a condition for distinguishing the first printing from the second printing, and may correspond to a stacking height or a stacking time.

When the power channel change condition is satisfied, the second printing (S16) may be performed using the power supplied from the second power supply, and at this time, gap control (S15) may be performed. Here, the second power supply device may be a power supply device of a constant voltage supply method or a constant current supply method, as will be described later. At this time, the gap control may apply all of the three logics described above.

Here, in the case of the pulse supply method, peak current needs to be measured, and gap control may be performed using the measured peak current.

In general, a voltage waveform during an on-time is a square waveform and has a constant value during the on-time. That is, this is because a function generator outputs a constant voltage. Therefore, the same voltage value may be obtained at every measurement time.

However, a waveform of current appears very irregular during the on-time. Therefore, a constant current value may not be obtained. For this reason, it is not easy to control the Z axis through a constant current value. The reason why the current waveform is irregular is that the electrolyte used in printing has capacitive/inductive reactance properties, which hinders current blur. In other words, the current waveform becomes very irregular due to the properties of the electrolyte itself to hinder passage of current.

In the present embodiment, this problem may not be resolved using a new type of AD converter.

Specifically, a current peak (maximum current) is obtained by sampling an irregular waveform at high speed within an on-time interval, and when one layer is stacked, an average of all peak values is obtained to obtain a cycle average current. Z-axis rise control, that is, gap control, may be performed using these values.

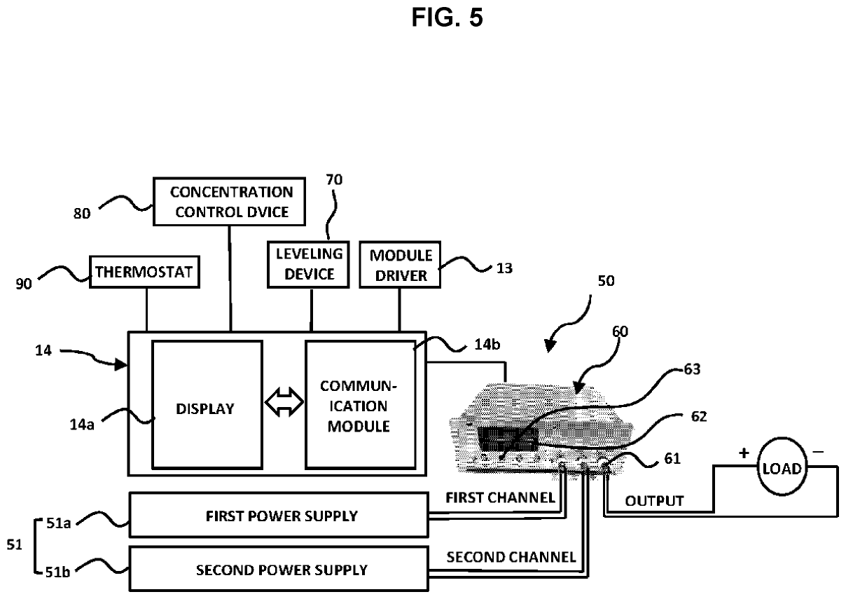

Hereinafter, a control configuration including the power supply 50 will be described in detail with reference to FIG. 5.

The controller 14 may be provided as a PC, and since the controller 14 controls the entire device, the controller 14 may be referred to as the main controller 14.

A control program may be installed in the controller, and a display 14a for a user interface may be provided in the controller. The display 14a may be provided in the form of a touch display, and thus the input and display may be supported.

The controller 14 may control an operation of the power supply 50 including the power source 51.

According to the present embodiment, the power supply 50 includes multiple power supplies 51a and 51b and an AD converter 60. Power from the power supply is delivered to a load through the AD converter 60. Here, the load may be a current flowing between the electrode and the substrate, and 3D printing is performed through the current flow.

The controller 14 controls the operation of the AD converter 60 through communication with the AD converter 60. To this end, the controller 14 may include a communication module 14b.

The AD converter 60 may be provided to selectively connect a first power supply 51a and a second power supply 51b to the load. That is, through the operation of the AD converter, power is supplied to the load through one of the power supply devices.

To this end, the AD converter 60 may have a housing defining an external shape, and a plurality of input terminals or output terminals 61 may be provided in the housing. A power terminal to which each power source is connected is provided, and this may be referred to as a power channel. FIG. 5 shows an example in which a first power supply and a second power supply are respectively connected to two power channels. The output terminal may be connected to the load. A terminal to which power is input may be referred to as a power channel connector, and an output terminal may be referred to as an output connector.

The housing may include a display 62 and an inputter 63. The display may display various types of information and manually switch power channel selection through the inputter.

The input terminal or output terminal may include a communication connection terminal and a power terminal. The power terminal may be a terminal to connect power for an operation of the AD converter itself.

Here, the first power supply 51a and the second power supply 51b may be different types of power supplies. The first power supply may correspond to a pulse input method, and the second power supply may correspond to a constant current or constant voltage input method.

When the controller 14 transmits a power channel selection command to the AD converter, the AD converter selects a specific channel according to the received command. Accordingly, power of a specific channel is supplied to the load.

The 3D printing device 10 according to the present embodiment may include various control components as well as the power supply 50 and the module driver 13 described above.

The module driver 13 controlling movement of the electrode module in three dimensions may accurately control movement of the electrode module on the premise that the substrate is fixed horizontally.

Accordingly, a leveling device 70 may be provided as a device for leveling the substrate. For example, the leveling device 70 may be provided in the form of a 2-axis gonio stage.

A gap sensor (not shown) may be mounted on the electrode module, and after obtaining height information about three points on a top surface of a stage, a level may be adjusted by driving the stage in two axes, Control of the leveling device may be performed by the main controller 14.

The temperature of the electrolyte is very important. That is, this is because a resistance value of the electrolyte itself varies depending on the temperature of the electrolyte at the same concentration. Therefore, in the present embodiment, a thermostat 90 may be provided to control the temperature of the electrolyte.

The thermostat 90 may include a temperature sensor to sense the temperature of the electrolyte and a heater to heat the electrolyte. The thermostat 90 may include a cooler to lower the temperature. The control of the thermostat may be performed in the main controller 14.

In addition to the temperature of the electrolyte, the concentration of the electrolyte is also very important. This is because the amount of metal ions dissolved in the electrolyte inevitably decreases as 3D printing is performed, and in particular, a change in concentration due to evaporation of moisture in the electrolyte during the process may increase. Therefore, it is important to always keep the electrolyte concentration constant. This is because the magnitude of the resistance at the load changes according to the change in concentration, which changes the magnitude of the current at the load.

In the present embodiment, a concentration control device 80 may be provided to adjust the concentration of the electrolyte.

The concentration control device 80 may include an auxiliary tank not shown in FIG. 1. The auxiliary tank may be provided to automatically adjust a level of the electrolyte in the storage 15.

Specifically, the storage 15 may include a water level sensor. A water level of the storage may be maintained at a constant level through the water level sensor. That is, when the water level drops, electrolyte may be supplied to the storage 15 through the auxiliary tank.

To this end, the auxiliary tank is provided above the storage 15, and a valve may be provided in the auxiliary tank. The valve may be controlled to be opened by an operating command from the main controller 14. That is, the valve is closed in normal times, but when a level of the electrolyte is low, the valve may be opened and the electrolyte may be supplied from the auxiliary tank to the storage. When the water level reaches a set level, the water level sensor may sense the water level, and the main controller may close the valve.

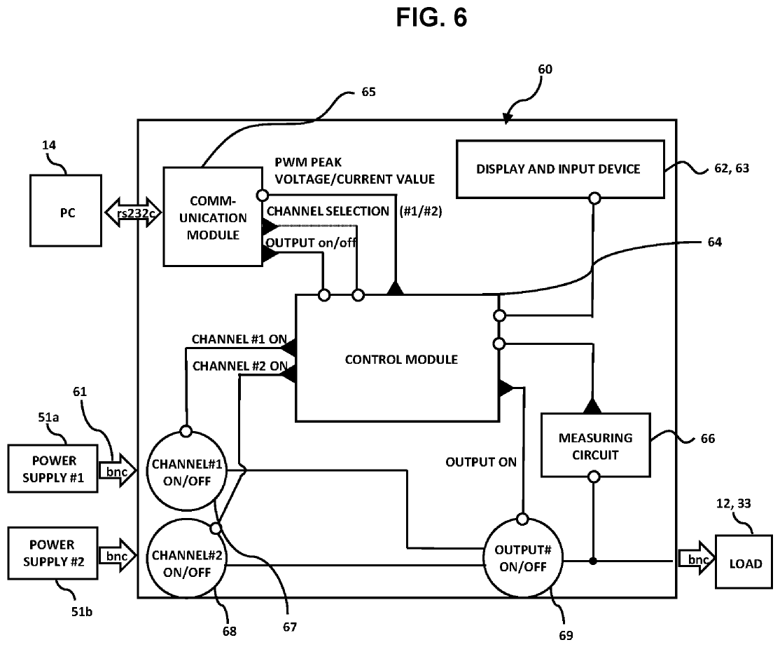

The AD converter will be described in more detail with reference to FIG. 6.

The AD converter 60 may include a control module 64 that controls the operation of the AD converter 60. The control module 64 controls its own operation and executes a command received through a communication module 65.

The AD converter 60 may include switching parts 67 and 68, The switching parts may be provided to select a power supply that currently performs power input through control of the control module 64.

Specifically, a first power channel switch 67 for turning on/off connection with the first power supply 51a and a second power channel switch 68 for turning on/off connection with the second power supply 51b may be provided. When one power supply is connected, the other power supply may be disconnected.

The AD converter 60 may include an output switch 69. An output switch 69 may be provided to forcibly turn off power applied to loads 12 and 33. It is necessary to artificially turn off a power source during 3D printing. This will be described later.

Therefore, it is possible to release output from the output terminal instead of disconnecting the power supply applied to the AD converter.

A measuring circuit or a measurer 66 may be provided at the output terminal. The voltage and current values measured by the measurer 66 are delivered to the control module 64, and the control module 64 delivers the voltage and current values to the controller 14.

The measurer 66 measures the voltage input to the load using a PWM. The measurer 66 measures the current peak in an on-time interval at high speed with a frequency of 100 Hz or more. That is, the current peak may be obtained by sampling an irregular waveform at high speed in the on-time interval.

When stacking of one layer is completed, a cycle average current may be calculated by averaging all current peak values. Needless to say, the calculation may be performed by the controller 14.

The controller 14 controls the operation of the driver 13 based on a rise amount calculated through calculation to control 3D driving of the electrode including gap control. That is, the controller controls 3D printing while appropriately performing gap control through the measured voltage and current values.

Eventually, the controller 14 controls the AD converter, and specifically, performs control to select a power input channel, output on/off control, and voltage and current monitoring through the AD converter.

The above-described manipulation buttons may be provided to manually input power channel No. 1 selection, power channel No. 2 selection, load output on, and load output off, respectively.

The specifications of the AD converter 60 may be as follows.

The input power may be DC 24V, and an input voltage range may be DC 0 to 20V. A current measurement range may be 0 to 100 mA, and the input voltage and current measurement may be performed at 100 hz or more.

The display may display a function generator input voltage and display the measured current. The input voltage display may mean a PWM peak voltage, and the measurement current may mean peak current.

The first power supply may be a function generator as a main power supply, and the second power supply may have an amplifier as a sub power supply.

There are cases in which layers of complex 3D shapes may not be drawn with a single brush. That is, there may be layers in which electrodeposition is to be performed discontinuously. In this case, there are cases in which output power needs to be momentarily turned off and then turned on during movement of the electrode. In the present embodiment, output on/off switching may be performed at a very high speed through the AD converter. Accordingly, it is possible to smoothly perform 3D printing on discontinuous layers.

1. A three-dimensional (3D) printing device comprising:
a tub accommodating an electrolyte;
a substrate placed in the tub;
an electrode module;
a module driver configured to drive the electrode module and adjust 3D movement including movement in a direction toward a gap between the electrode and the substrate;
an AD converter configured to connect the electrode module and the substrate to different polarities and including a switching part;
a first power supply selectively connected to the AD converter through the switching part;
a second power supply selectively connected to the AD converter through the switching part and having a different power supply method from the first power supply; and
a main controller configured to control the module driver and the switching part,
wherein the main controller controls the gap by changing a method of supplying power to the AD converter.

2. The 3D printing device of claim 1, wherein the main controller changes the method of supplying power to the AD converter as a stacking height per cycle varies according to a stacked layer of the metal raw material.

3. The 3D printing device of claim 1, wherein the main controller changes the method of supplying power to the AD converter as a stacking shape per cycle varies according to a stacked layer of the metal raw material.

4. The 3D printing device of claim 1, wherein the main controller changes the method of supplying power to the AD converter as a stacked layer of a metal raw material varies.

5. The 3D printing device of claim 1, wherein the first power supply is a power supply that supplies a pulse, and the second power supply is a power supply that supplies constant current or constant voltage.

6. The 3D printing device of claim 5, wherein the switching part is driven to be selectively connected to any one of the first power supply and the second power supply for 3D printing.

7. The 3D printing device of claim 5, wherein rise control of the electrode for the gap control includes at least one of post-gap control performed after 1-cycle shift stacking or intermediate gap control performed during 1-cycle shift stacking.

8. The 3D printing device of claim 7, wherein the post-gap control is performed in a next cycle based on a rise amount calculated after the 1-cycle shift stacking is completed.

9. The 3D printing device of claim 7, wherein the post-gap control is performed in a next cycle based on a preset rise amount after the 1-cycle shift stacking is completed.

10. The 3D printing device of claim 7, wherein the intermediate gap control is performed during the 1-cycle shift stacking based on a rise amount determined through feedback during the 1-cycle shift stacking.

11. The 3D printing device of claim 5, wherein the main controller controls power to be supplied through the first power supply at beginning of stacking, and then controls power to be supplied through the second power supply.

12. The 3D printing device of claim 5, wherein the main controller controls power to be supplied to a preset stacking height through the first power supply and then controls power to be supplied until end of stacking through the second power supply.

13. The 3D printing device of claim 1, wherein the AD converter includes;
a channel connector to which the first power supply and the second power supply are each connected;
a control module including the switching part and configured to control a connection channel and output; and
a communication module configured to communicate with the main controller.

14. The 3D printing device of claim 13, wherein the AD converter includes an output on/off switch.

15. The 3D printing device of claim 13, wherein the switching part includes a switch configured to turn on/off each of a channel connected to the first power supply and a channel connected to the second power supply.

16. The 3D printing device of claim 13, wherein:
the AD converter includes a peak detector configured to detect a peak of output; and
the control module is configured to measure an input voltage and measure current through the peak of the output detected by the peak detector.

17. The 3D printing device of claim 16, wherein the AD converter includes a display configured to display a currently connected power input channel and the measured voltage and current.

18. The 3D printing device of claim 16, wherein:
the main controller transfers information on a power input channel selected by the control module and output on/off information to the AD converter through the communication module; and
the AD converter transfers the measured input voltage and current to the main controller through the communication module.

19. A method of controlling a 3D printing device, comprising:
supplying current between an electrode module and a substrate through an AD converter from a first power supply connected to a first channel of the AD converter;
performing first printing in which power is supplied through the first power supply and then gap rise control of the electrode module is performed;
supplying current between the electrode module and the substrate through the AD converter from a second power supply connected to a second channel of the AD converter; and
performing second printing in which power is supplied through the second power supply and then the gap rise control of the electrode module is performed,
wherein the second power supply has a different power supply method from the first power supply.

20. The method of claim 19, wherein the first power supply is a power supply configured to supply a pulse, and the second power supply is a power supply configured to supply constant current or constant voltage.
